(19) United States
(12) Patent Application Publication
(10) Pub. No.: US 2012/0020386 A1
(43) Pub. Date: Jan. 26, 2012

(54) Temperature Sensor

(76) Inventors: Peter MUELLER, Markgroeningen (DE); Heiner Lehmann, Ludwigsburg (DE); Robert Hartmann, Tamm (DE)

(21) Appl. No.: 13/186,678

(22) Filed: Jul. 20, 2011

(30) Foreign Application Priority Data
Jul. 22, 2010 (DE) 10 2010 031 917.1

(51) Int. Cl. G01K 7/16

(52) U.S. Cl. 374/185; 374/E07.018

(57) ABSTRACT

The invention relates to a temperature sensor comprising a measuring resistor which is connected via a connection wire to an interconnecting wire, and a protective sleeve that contains filler material in which the measuring resistor is embedded, wherein the connection wire is shaped into a curve. According to the invention, the curve extends along an end section of the interconnecting wire.

The invention is directed to a temperature sensor having a measuring resistor composed of a chip as the carrier and resistance material such as platinum disposed thereon. The measuring resistor, embedded in filler material, is disposed in a protective sleeve, and is connected via a connection wire section to an interconnecting wire that extends out of the protective sleeve. The connection wire section is shaped into a curve in order to compensate for mechanical loads that can be produced by temperature changes.

The operating conditions for temperature sensors in the exhaust-system branch of internal combustion engines are harsh. They are characterized by high temperatures of over 600° C. to close to 1000° C., rapid temperature changes, e.g. temperature increases of 800° C. in fewer than 2 seconds, vibrations, and being surrounded by aggressive media. Rapid temperature changes, combined with different coefficients of thermal expansion of the filler material and the wires in particular, result in loads being placed on the wires that can cause them to break.

A problem addressed by the present invention, therefore, is that of demonstrating a way to extend the service life of temperature sensors in the exhaust-system branch of internal combustion engines.

### SUMMARY OF THE INVENTION

This problem is solved by a temperature sensor having the features indicated in claim 1. Advantageous refinements of the invention are the subject matter of dependent claims.

In the case of a temperature sensor according to the invention, the measuring resistor is connected via a connection wire to an interconnecting wire, wherein the connection wire is shaped into a curve that extends in a movable manner along an end section of the interconnecting wire. The connection wire section is fastened at one end of the curve to the interconnecting wire, namely at a point that is situated at a distance from the end of the interconnecting wire facing the measuring resistor. This means that a joint between the interconnecting wire and the connection wire is situated at a distance from the ends of the interconnecting wire. The joint may be weld, for example.

While the connection wire section utilized in conventional temperature sensors is attached directly to the end of the interconnecting wire, the connection wire of a temperature sensor according to the invention is attached to the interconnecting wire at a distance from the end thereof that faces the measuring resistor. The connection wire section, which is shaped into a curve, therefore extends in a movable manner along an end section of the interconnecting wire.

In a method according to the invention for producing a temperature sensor, a measuring resistor is therefore connected via a connection wire section to an interconnecting wire, and is then embedded in filler material in a protective sleeve, wherein the connection wire section is connected to the interconnecting wire by attaching the connection wire section to a connection point of the interconnecting wire that is situated at a distance from the end of the interconnecting wire facing the measurement resistor.

Different thermal expansions of the protective sleeve, the filling compound, the measuring resistor, or wires can result in temperature-induced relative motions between the measuring resistor and the interconnecting wire, thereby placing a mechanical load on the connection wire. In conventional temperature sensors, this load on the connection wire frequently causes the temperature sensor to fail because the connection wire breaks.

If temperature-induced relative motions occur between the measuring resistor and the interconnecting wire, the end section of the interconnecting wire—in the case of a temperature sensor according to the invention—can function as a stop for the measuring resistor and thereby relieve the connection wire. Movements of the measuring resistor in the opposite direction, i.e. away from the interconnecting wire, can be compensated for by an extension of the connection wire which has been shaped into a curve.

In this manner, in the case of a temperature sensor according to the invention, the connection wire is substantially relieved, thereby reducing the danger of the connection wire breaking. A temperature sensor according to the invention can therefore easily withstand even extreme temperature changes, and has an improved service life.

The measure according to the invention, namely that of fastening the curved connection wire at a distance from the end of the interconnecting wire facing the measuring resistor, is that much more advantageous the more sensitive the connection wire is compared to the interconnecting wire. Typically, the connection wire has a smaller cross-sectional area than the interconnecting wire, and so the mechanical loads it can sustain are substantially less. In particular, when a platinum metal alloy is used for the measuring resistor, such as a Pt-100 or Pt-200 resistor, the connection wire is typically composed of platinum or a platinum metal alloy and is therefore poorly suited for withstanding mechanical loads. Platinum and other platinum metals are relatively soft at high temperatures in particular, and so a wire composed thereof breaks much more easily than do lower-cost wires based on iron, nickel, or copper, which are preferably used for interconnecting wires.

According to an advantageous refinement of the invention, the interconnecting wire comprises a step, and the connection wire is fastened to the interconnecting wire in front of the step, as viewed from the measuring resistor. In this manner the production of a temperature sensor according to the invention can be simplified since the step advantageously enables the position for attaching the connection wire section to the interconnecting wire to be predetermined.

According to a further advantageous refinement of the invention, the measuring resistor comprises a carrier which supports an electrical conductor having a temperature-dependent resistance. The carrier is preferably a chip. Ceramic is suited in particular for use as the material for the carrier. The electrical conductor is preferably composed of platinum or a platinum metal alloy, such as a Pt-100 or Pt-200 resistor. However, an NTC resistor, for instance, can also be used for the measuring resistor, i.e. a material, the electrical resistance of which decreases as the temperature increases.

Preferably, the interconnecting wire points toward the carrier of the measuring resistor. This means that an imagined extension line of the interconnecting wire intersects the carrier. In production, the interconnecting wire is preferably mounted such that it abuts the carrier. A gap can form between the carrier and the interconnecting wire as a result of thermally induced relative motions or shaking during operation of a motor vehicle comprising the exhaust-system branch in which the sensor is installed. The carrier may be situated at a distance away from the interconnecting wire in a brand-new, i.e. unused sensor. This distance may be less than the thickness of the interconnecting wire, preferably less than 0.1 mm.

According to a further advantageous refinement of the invention, the interconnecting wire has a thickness of less than 0.4 mm, preferably at least 0.5 mm. In this manner, the interconnecting wire, as a stop, can prevent relative motion of the measuring resistor in a particularly effective manner. The cross-sectional area of the interconnecting wire is preferably at least twice as large or, particularly preferably, at least three times as large as that of the connection wire.

### BRIEF DESCRIPTION OF THE DRAWINGS

Further details and advantages of the invention are explained using an embodiment, with reference to the attached drawings. In the drawings:

FIG. 1 shows a schematic sectional view of an embodiment of a temperature sensor according to the invention.

### DETAILED DESCRIPTION

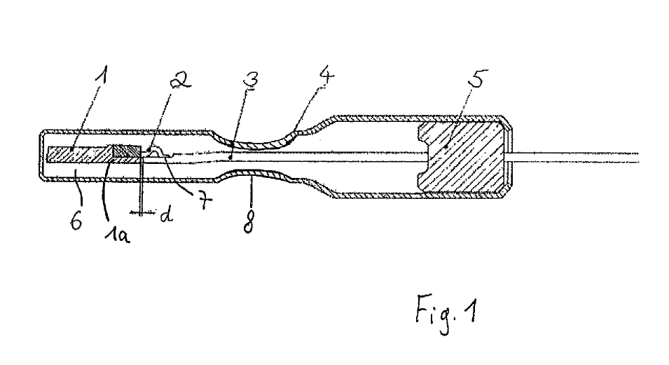

The temperature sensor shown in a schematic sectional view in FIG. 1 comprises a measuring resistor 1 which is connected via a connection wire 2 to an interconnecting wire 3. Measuring resistor 1 is embedded in filler material 6, such as ceramic powder or casting compound, and is enclosed by a protective sleeve 4. Protective sleeve 4 is closed at one end with a stopper 5, through which interconnecting wire 3 leads. At the other end, protective sleeve 4 comprises a base.

Measuring resistor 1 can be a flat measuring resistor, for instance. In the embodiment shown, measuring resistor 1 comprises a carrier la which is advantageously a chip. The carrier can be composed of ceramic, for example. As the resistance material, it is possible to use platinum metal alloys, in particular alloys composed of one or more platinum metals comprising more than 50% by weight, or NTC materials.

Connection wire 2 is shaped into a curve. The curve extends in a movable manner beyond an end section of interconnecting wire 3. Connection wire 2 is fastened at one end of the curve to interconnecting wire 3, e.g. by welding or brazing. Connection wire 2 is therefore fastened at a point 7 of interconnecting wire 3 that is situated at a distance from the end of interconnecting wire 3 facing measuring resistor 1. This means that the connection wire 2 is attached to the interconnecting wire 3 at an end of the curve such that a joint between the interconnecting wire 3 and the connection wire 3 is situated at a distance from the end of the interconnecting wire 3 facing the measuring resistor 1.

Interconnecting wire 3 points toward the carrier of measuring resistor 1. The carrier la is situated at a distance from the end of interconnecting wire 3 facing it that is less than the thickness of interconnecting wire 3, preferably less than 0.1 mm. In the embodiment shown, distance d between interconnecting wire 3 and measuring resistor 1 is less than 0.05 mm. That is, interconnecting wire 3 is mounted such that it abuts measuring resistor 1.

If measuring resistor 1 is moved toward stopper 5 due to thermally induced changes in length, the end of interconnecting wire 3 facing measuring resistor 1 can function as a stop and prevent a mechanical load from being placed on connection wire 2. Conversely, when measuring resistor 1 undergoes a relative motion away from interconnecting wire 3, the curve of connection wire 2 can extend, thereby preventing that connection wire 2 breaks.

Connection wire 2 is composed of a platinum metal alloy, preferably platinum or a platinum-base alloy, and is therefore relatively soft at higher temperatures. In contrast, interconnecting wire 3 can be produced from a material that is capable of sustaining a greater mechanical load, such as a nickel-base alloy such as Inconel. In the embodiment shown, interconnecting wire 3 has a greater cross-sectional area than does connection wire section 2, preferably a cross-sectional area that is at least twice as great. Interconnecting wire 3 can have a thickness of 0.5 mm, for instance; connection wire section 2 has a thickness of 0.3 mm or less.

To simplify production, interconnecting wire 3 can comprise a step. Connection wire section 2 is fastened in front or upstream of the step on interconnecting wire 3, as viewed from measuring resistor 1. The step can therefore be used to mark the point 7 where connection wire section 2 should be attached, e.g. by soldering, brazing or welding.

To produce the temperature sensor depicted in FIG. 1, measuring resistor 1 is connected to interconnecting wire 3 by connection wire 2 by attaching connection wire 2 to a connection point 7 of interconnecting wire 3 that is situated at a distance from the end of interconnecting wire 3 facing measuring resistor 1, Connection wire 2 is thereby shaped into a curve that extends beyond an end section of interconnecting wire 3 up to connection point 7. Next, measuring resistor 1 is embedded in filler material 6 in protective sleeve 4, and protective sleeve 4 is closed, e.g. using a stopper 5 which is preferably composed of ceramic material.

Ceramic powders can be used as filler material 6, in particular those composed of magnesium oxide, aluminum oxide, or aluminum nitride. Instead of powders, ceramic casting compounds such as Cerastil-V 336 can also be used as filler material.

Interconnecting wire 3 can be additionally affixed by way of a constriction of protective sleeve 4. Only a single interconnecting wire 3 comprising connection wire section 2 fastened thereto is shown in the side view in FIG. 1. A further interconnecting wire that is connected to measuring resistor 1 via a further connection wire section typically extends next to interconnecting wire 3 that is shown. The further interconnecting wire and the further connection wire can be designed and connected in the same manner.

### REFERENCE NUMERALS

1 Measuring resistor
1a Carrier
2 Connection wire section
3 Interconnecting wire
4 Protective sleeve
5 Stopper
6 Filler material
7 Connection point
8 Constriction
d Distance

What is claimed is:

1. A temperature sensor, comprising:
a measuring resistor;
a protective sleeve containing a filler material embedding said measuring resistor;
an interconnecting wire; and
a connector wire connecting said measuring resistor and said interconnecting wire, said connecting wire being shaped into a curve extending along an end section of said interconnecting wire.

2. The temperature sensor according to claim 1, wherein the connection wire is attached to the interconnecting wire at an end of the curve with a joint between the interconnecting wire and the connection wire situated at a distance from the end of the interconnecting wire facing the measuring resistor.

3. The temperature sensor according to claim 1, wherein the interconnecting wire comprises a step, and wherein the connection wire section is attached to the interconnecting wire in front of the step, as viewed from the measuring resistor.

4. The temperature sensor according to claim 1, wherein the measuring resistor comprises a carrier.

5. The temperature sensor according to claim 4, wherein the interconnecting wire points toward the carrier.

6. The temperature sensor according to claim 5, wherein the interconnecting wire abuts the carrier.

7. The temperature sensor according to claim 4, wherein the carrier is situated at a distance from the end of the interconnecting wire facing it, that distance being less than the thickness of the interconnecting wire.

8. The temperature sensor according to claim 1, wherein the connection wire section is attached to the interconnecting wire by welding.

9. The temperature sensor according to claim 1, wherein the connection wire section is composed of platinum or a platinum metal alloy.
